(19) United States
(12) Patent Application Publication
(10) Pub. No.: US 2011/0286533 A1
(43) Pub. Date: Nov. 24, 2011

(54) INTEGRATED RECORDING AND VIDEO ON DEMAND PLAYBACK SYSTEM

(76) Inventors: Douglas P. Fortney, Akron, OH (US); Jeremy W. Weatherford, Sioux Falls, SD (US)

(21) Appl. No.: 13/033,479

(22) Filed: Feb. 23, 2011

Related U.S. Application Data
(60) Provisional application No. 61/307,269, filed on Feb. 23, 2010.

(51) Int. Cl. H04N 7/26

(52) U.S. Cl. 375/240.28; 375/E07.2

(57) ABSTRACT

An apparatus including an encoder and an editor is provided. The encoder is configured to receive an instruction datum, receive a content datum, receive a return processing signal that includes at least one of a wait signal, and an upload signal, synchronize the content datum, encode the content datum according to the instruction datum, and store the encoded datum. The editor is configured to control a one or more input devices, communicate to a remote device through a communication network, communicate a notice of available upload to the remote device upon completion of encoding, rebroadcast the notice of available upload at a predetermined cycle upon the encoder receiving the return processing signal of the wait signal, and upload the encoded datum upon the encoder receiving the return processing signal of the upload signal.

### CROSS-REFERENCE TO RELATED APPLICATIONS

This application claims the priority of U.S. Provisional Patent Application Ser. No. 61/307,269 filed Feb. 23, 2010, titled “INTEGRATED RECORDING AND VIDEO ON DEMAND PLAYBACK SYSTEM,” which is hereby incorporated by reference herein in its entirety.

### TECHNICAL FIELD

The devices, methods, and systems described below relate generally to the field of information capture, including recording and playback. More particularly, those devices, methods, and systems relate to making, storing and accessing audio, video, and data, including live feed and prerecorded videos with options for multi-screen viewing and controlled access.

### SUMMARY

An apparatus includes an encoder and an editor. The encoder is configured to receive an instruction datum, receive a content datum, receive a return processing signal that includes at least one of a wait signal and an upload signal, synchronize the content datum, encode the content datum according to the instruction datum, and store the encoded datum. The editor is configured to control a one or more input devices, communicate to a remote device through a communication network, communicate a notice of available upload to the remote device upon completion of encoding, rebroadcast the notice of available upload at a predetermined cycle upon the encoder receiving the return processing signal of the wait signal, and upload the encoded datum upon the encoder receiving the return processing signal of the upload signal.

An apparatus can be configured such that encoded data comprises the content datum from each of two or more input devices and the encoder is further configured to encode such that the encoded data can be operatively selected to contemporaneously display a variety of content from the two or more input devices based on a preference, the preference comprising at least one of pre-defined preference and user selected preference.

An apparatus can be configured such that the editor is further configured to communicate a notice of available livestream upload to the remote device during encoding, rebroadcast the notice of available livestream upload at a predetermined cycle upon the encoder receiving the return processing signal of the wait signal, upload a live stream encoded datum upon the encoder receiving the return processing signal of the upload signal, and communicate the live stream encoded datum to a client browser through a communication network.

An apparatus can be configured such that the editor is further configured to monitor the upload of the encoded datum and if the upload of the encoded datum is prematurely terminated communicate a notice of available upload to the remote device, rebroadcast the notice of available upload at a predetermined cycle upon the encoder receiving the return processing signal of the wait signal and upload the encoded datum upon the encoder receiving the return processing signal of the upload signal, wherein the upload starts at a preselected point from a group including at least one of an interruption point of the terminated upload and a beginning point of the encoded data.

An apparatus can be configured such that the encoder is further configured to receive the instruction datum from a group comprising at least one of a controller, manual entry, and the remote device.

An apparatus can be configured such that the instruction datum comprises at least one of a pre-selected metadata and a communication protocol for one or more input devices, and the encoder converts the instruction datum into a format recognized by the one or more input devices.

An apparatus can be configured such that the content datum comprises at least one of an input device identifier, a content, and a metadata.

An apparatus can be configured such that the content datum further comprises the content from a group including at least one of a one or more capture devices, a digital signal processor, a video editor, and a content marker.

An apparatus can be configured such that the encoder is further configured to encode with a digital signature.

### BRIEF DESCRIPTION OF THE DRAWINGS

FIG. 1 is a system block diagram of an information capture and playback system.

FIG. 2 is a system block diagram of an encoder module.

FIG. 3 is a system block diagram of an editor module.

FIG. 4 is a system block diagram of a source module.

FIG. 5 is a system block diagram of a server module.

FIG. 6 is a system block diagram of a client module.

### DETAILED DESCRIPTION

The devices, methods, and systems disclosed and described in this document can be used to distribute various forms of electronically formatted information, including streaming media. For ease of description, the examples included in this document focus on a distribution system arranged in a client-server architecture and sometimes reference various communication protocols that can be used in a network protocol stack model. Those of ordinary skill in this art area will recognize from reading this description that the devices, methods, and systems described can be applied to, or easily modified for use with, other types of equipment, other protocols, and at other layers in a communication protocol stack. Descriptions of components presented solely as part of a client-server architecture do not imply that other architectures, such as peer-to-peer or distributed architectures, could not be used. To the contrary, possible modifications will be apparent to people of ordinary skill in this area after reading disclosures in this document. Like reference numerals are intended to refer to the same or similar components.

Throughout this disclosure, references to components or modules generally refer to items that logically can be grouped together to perform a function or group of related functions. Components and modules can be implemented in software, hardware, or a combination of software and hardware. The term software is used expansively to include not only executable code, but also data structures, data stores and computing instructions in any electronic format, firmware, and embedded software. The term “information” is used expansively and includes a wide variety of electronic information, including but not limited to machine-executable or machine-interpretable instructions; content such as text, video data, and audio data, among others; and various codes or flags. The terms “in formation” and “content” are sometimes used interchangeably when permitted by context. It should be noted that although for clarity and to aid in understanding some examples discussed below might describe specific features or functions as part of a specific component or module, or as occurring at a specific layer of a computing device (for example, a hardware layer, operating system layer, or application layer), those features or functions may be implemented as part of a different component or module or at a different layer.

The examples discussed below are examples only and are provided to assist in the explanation of the systems and methods described. None of the features or components shown in the drawings or discussed below should be taken as mandatory for any specific implementation of any of these systems or methods unless specifically designated as mandatory. For ease of reading and clarity, certain components, modules, or methods may be described solely in connection with a specific figure. Any failure to specifically describe a combination or subcombination of components should not be understood as an indication that any combination or subcombination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented may be performed in a different order or in parallel.

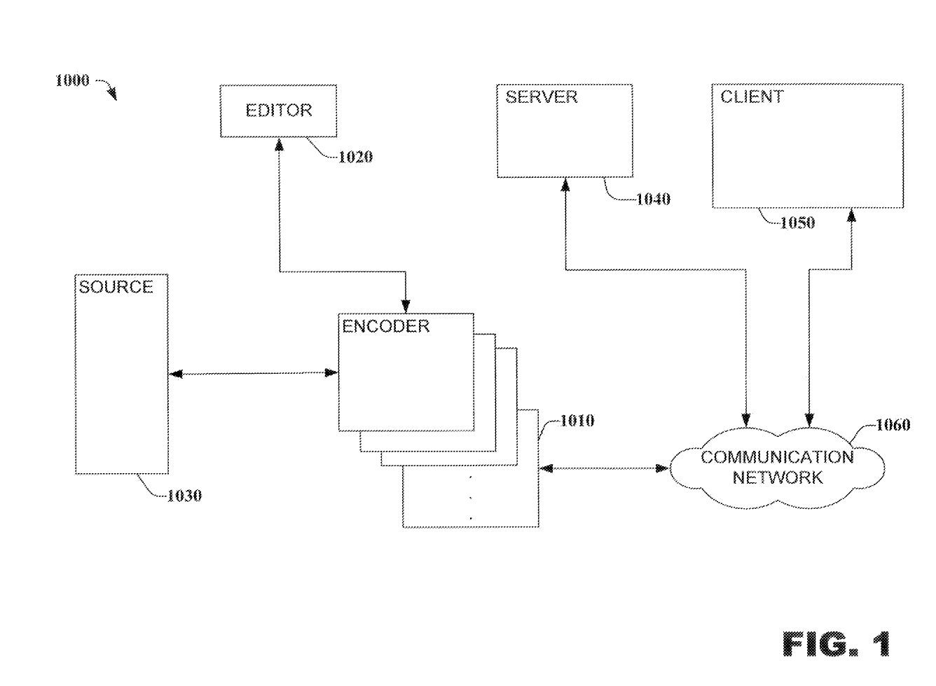

An information capture and playback system 1000, as shown in FIG. 1, can include an encoder module 1010, an editor module 1020, a source module 1030, a server module 1040, and a client module 1050. The information capture and playback system 1000 can also be in communication with a communication network 1060. The communication network 1060 can be, for example, the Internet, a local area network, a wide area network, or other suitable communication network, to facilitate communication among components or modules of the information capture and playback system 1000 or components or modules outside the information capture and playback system 1000.

The information capture and playback system 1000 can provide for the capture and recording of content in a number of controlled manners and formats. That content can include, among other things, audio-visual content and data from an electronic computing device or other source. Once captured, the content can be forwarded for immediate playback or stored for subsequent playback. The information capture and playback system 1000 can be configured so that playback of the captured content is on an as-demanded basis.

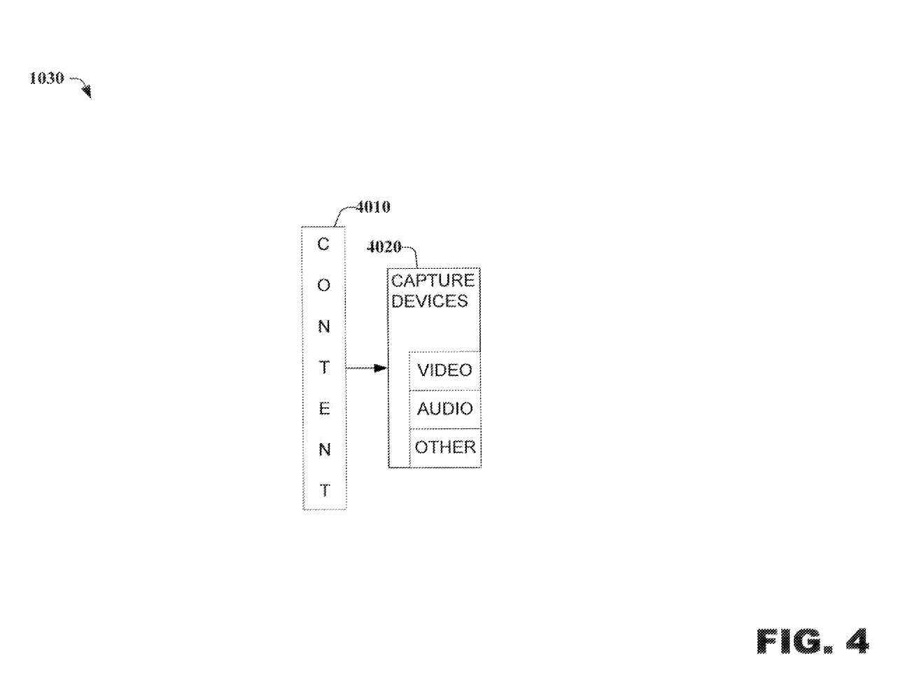

As shown in FIG. 4, the source module 1030 can include content 4010 and capture devices 4020. Content 4010 can originate from multiple sources such as, for example, live or previously captured video and audio content, multimedia files, and computer tiles. In one example, the content 4010 can be live or previously captured and stored video or audio content of an instructor demonstrating a task or lesson. In another example, the content 4010 can be stored digital content such as documents, electronic presentations or other suitable forms of electronically stored information.

The information capture and playback system 1000 can include a number of components or modules. Several of these components or modules can be collocated and configured to capture the content 4010. Other components or modules can be remotely located and configured to store, manage, or display the content 4010.

The information capture and playback system 1000 can be accessed by a number of users (not shown). For example, a system operator can control components or modules of the system to capture the content 4010. In another example, an end user (not shown) can request delivery of content for remote viewing. In yet another example, a system administrator (not shown) can access multiple components or modules of the information capture and playback system 1000. Through such access, the system administrator can control, for example, security, functionality, and administrative rights for the information capture and playback system 1000.

With reference to FIG. 4, the information capture and playback system 1000 can include one or more capture devices 4020. Such capture devices 4020 can include video capture devices. Suitable video capture devices can include various types of cameras, both film-based and digital. Cameras can include video cameras with pan-tilt and zoom capabilities, or other high-resolution video capture devices. Cameras can be any composite camera or other video output device, any s-video device, any component video device, any RGBHV or DVI video device. The capture devices 4020 can also include audio capture devices such as microphones. Other capture devices can be used for a wide variety of other types of information to be captured, such as information in electronic files that can be accessed by a computing device. The content 4010 can he captured in one or more locations by various capture devices 4020.

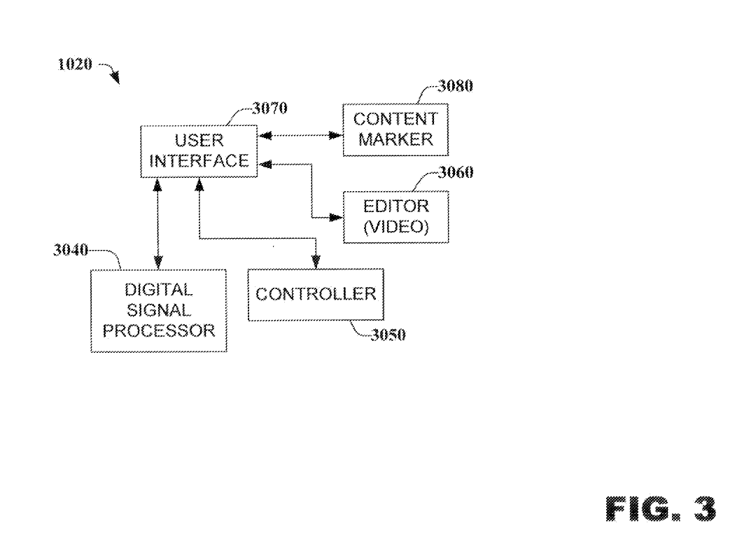

As shown in FIG. 3, the editor module 1020 can include a digital signal processor 3040, a controller 3050, a video editor 3060, a user interface 3070, and a content marker module 3080. The digital signal processor 3040 can communicate with the capture devices 4020 and can digitize any content captured by the capture devices 4020. In one example, the digital signal processor 3040 can be, for example, an audio mixer with AEC, NC and AVC. The physical capturing of audio content 4010 can be aided by an audio capture card used as part of the capture devices 4020. Audio portion of the content 4010 can be processed by the digital signal processor 3040 to mix audio sources of the content 4010, regulate audio levels, cancel out unwanted ambient room noise, and provide delay to assist in synchronization of audio content with other types of content.

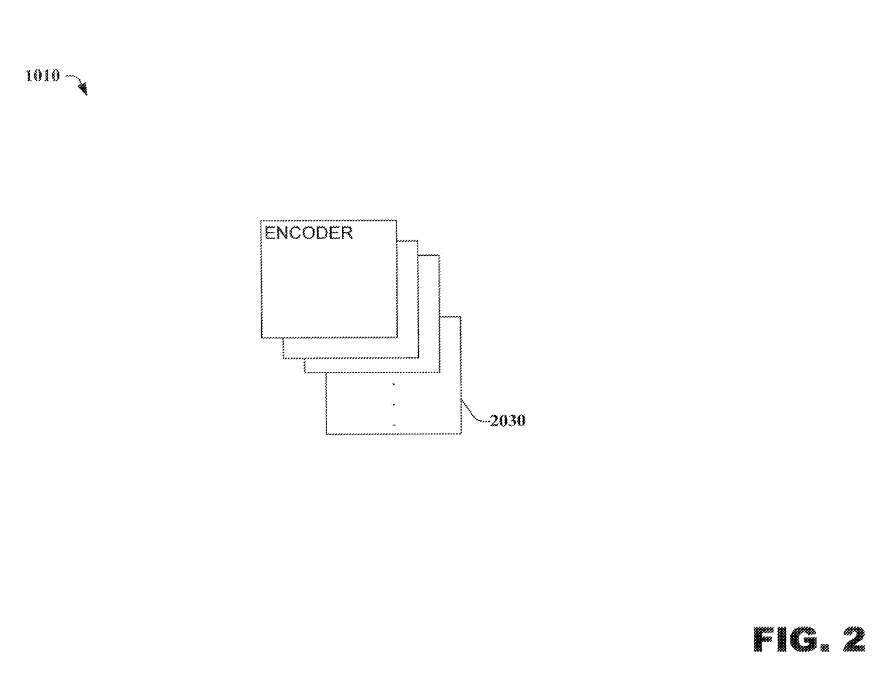

The information capture and playback system 1000 can contain an encoder module 1010. As shown in FIG. 2, the encoder module 1010 can include one or more encoders 2030. Each encoder 2030 can be used to convert the content 4010 captured by the capture devices 4020 into an electronic format that can be used and manipulated by other components of the system. Specifically, each encoder 2030 can accept electronic signals that encode the content 4010 and translate those signals into a suitable format using an encoding—decoding algorithm (“codec”) such as AAC, WMV, or Ogg Theora, among others.

The controller 3050 can be configured to interface with multiple components or modules of the information capture and playback system 1000 such as, for example, one or more encoders 2030 or the capture devices 4020. The controller 3050 can be used to control standard functions of the capture devices 4020, such as power cycling, playback, directional control, zoom, and focus, among others. It should be appreciated that the types of available control functions is dictated at least in part by the functionality provided by specific components of the capture devices 4020.

The information capture and playback system 1000 can include a user interface 3070. The user interface 3070 can be any suitable user interface, including a graphical user interface (“GUI”) (including those for touch screens), a textual interface, or a mechanically actuated interface. In this example, the user interface 3070 is presented as a touch screen with a GUI. The touch screen 3070 can include one or more buttons to perform functions. In other examples the user interface 3070 can include a display device along with other input devices such as a computer screen, keyboard, mouse, stylus, audio command recognition or the like.

The video editor 3060 can be a suitable software component that provides abilities to manipulate electronically formatted video content. The video editor 3060 can be operatively connected to the user interface 3070 to process or edit the data file.

The content marker module 3080 can he a touch panel, USB foot pedal or wireless USB remote control or other suitable device. The user interface 3070 can be operatively connected to the content marker module 3080. While the content 4010 is being captured, or at a later point, the content marker module 3080 can mark points in the content 4010. Marking can be accomplished through the creation of a metadata file. The metadata file can be an extensible markup language (XML) file that includes tags that can be keyed to time stamps on a suitably encoded file that stores an encoded version of the content 4010.

The user interface 3070 can display the content marker in examples where the content marker is implemented as part of a GUI. Specific events during a capture session can be identified by the user and those events can be marked by name during the capture session. In one example, there is only one marker button for content marking in the user interface 3070. In other examples, the marker button interface can add buttons for different types of markers, or even a field to enter custom marker text and other metadata that will be associated with the file processed by the encoder module 1010.

The encoder module 1010 can interface with several components or modules and provide control by sending control signals over a data pathway. Suitable data pathways include protocols available through wired or wireless communication systems such as Recommended Standard 232 (RS-232), Universal Serial Bus (“USB”), or IEEE 802.11x.

For example, the encoder module 1010 can he configured to interoperate with a multi-window video processor with scaler, (not shown), capture devices 4020, the digital signal processor 3040, and the video editor 3060. The encoder module 1010 can be programmed or can be configured by the controller 3050 through the user interface 3070. A user such as, for example, the system operator or the system administrate can define or designate certain metadata such as the location of the encoder module 1010, a room name or number, a primary user such as an instructor or judge, or other suitable metadata. In addition to the capture of audio and video information, additional information can be associated with the captured content.

As previously described, the encoder module 1010 can include multiple encoders 2030. Each encoder 2030 can process multiple capture devices 4020. In one example, each encoder 2030 can be configured to process content captured by multiple capture devices 4020. The content 4010 captured by the capture devices 4020 can be encoded as a digital file by the encoder 2030. The encoded digital file can be stored and organized on the encoder 2030 or stored on removable memory devices (not shown) such as, for example, flash drives, memory sticks, external disk drives, or other suitable memory devices. The encoder 2030 can supply the parameters that control the capture device 4020.

The encoder 2030 can be configured to control one or more components that are configured to capture content such as, for example, the capture devices 4020, the digital signal processor 3040, the controller 3050, and the video editor 3060. For example, the encoders 2030 can be configured to enable the user interface 3070 to have a multi-window configuration to provide graphical representation and associated multiple video feeds. In another example, the user interface 3070 can include touch screen capability and can be configured to control the capture devices 4020 based on the system operator touching corresponding region of the window display that correspond to the capture devices 4020. When the graphical representation is selected, the user interface 3070 can display the controls available for the selected device. The video window configurations can be changed by the system operator through the touch screen 3070 without interrupting the recording. Data can be added to the recording before, during or after the recording session through the touch screen 3070.

In one example, the encoder 2030 can be configured to display a control on the user interface 3070 that accept input from the digital signal processor 3040 to control features such as volume for audio sources and volume meter for the audio sources. The digital signal processor 3040 can provide output to the encoder 2030. The encoder 2030 can create a single data file integrating the information from the capture devices 4020 with the processed audio information from the digital signal processor 3040. Synchronization of data from the capture devices 4020 is done by the encoder 2030. The processed audio from the digital signal processor 3040 can be encoded with the video feed as part of a windows media video file (WMV file) by the encoder 2030.

In other examples, the encoder 2030 can be likewise configured with one or more additional controls. For example, the encoder 2030 can be configured with controls to display and accept input for recording controls, recording information, name, title, length of recording, keywords, tracking and displaying status of recording including elapsed time and recording a live status, and interfacing with content marker module 3080.

In one example, the recording can be initiated by pressing the start button on the touch screen 3070. If the tile name has not been defined by the system operator through the touch screen 3070, the encoder 2030 will automatically generate a file name based on the location of the encoder 2030, and date and time of day. Several auto naming parameters can be predefined at the time the encoder 2030 is setup if desired by the system operator or system administrator.

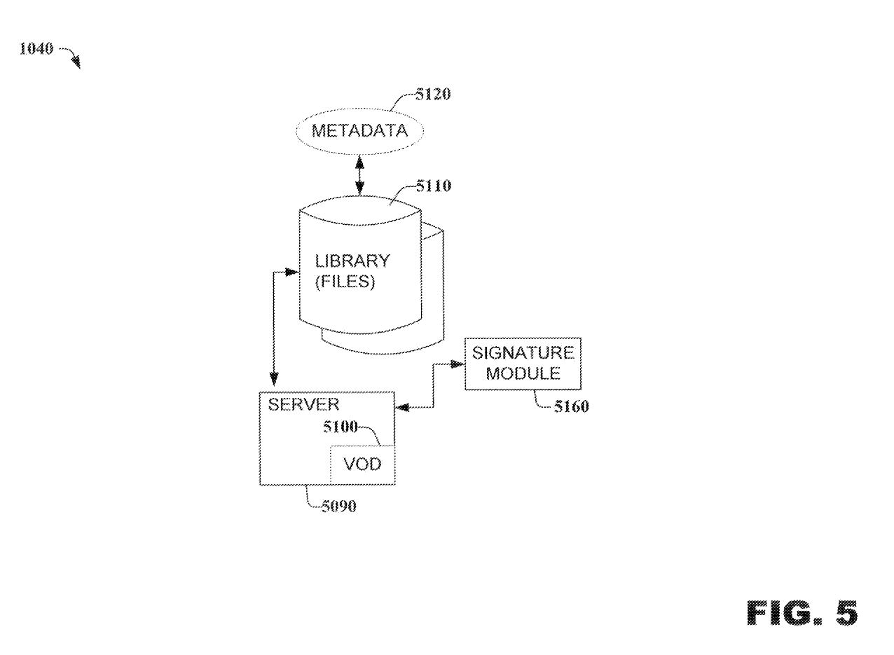

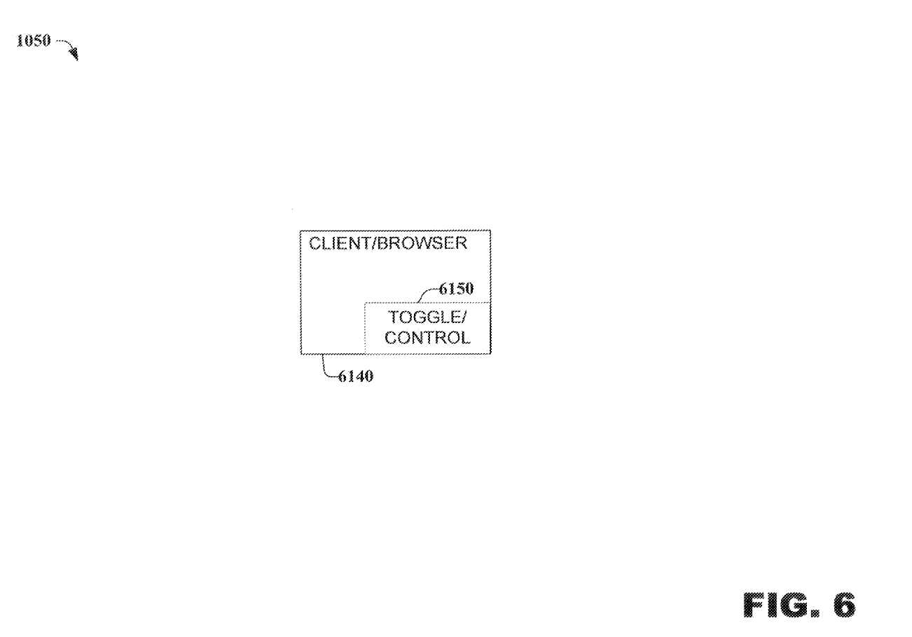

As shown in FIG. 5, the server module 1040 can include a server 5090, with a video on demand (“VOD”) module 5100, a library 5110, a metadata 5120, and a signature module 5160. The server 5090 can be configured to be placed in communication with other components of the information capture and playback system 1000. By placing the server 5090 in communication with other components or modules of the information capture and playback system 1000, the sever 5090 can, for example, receive commands, requests, and data from other components of the information capture and playback system 1000. Correspondingly, the server 5090 can, for example, also send commands, requests, and data to other components of the information capture and playback system 1000. In an example, the server 5090 can be placed in communication with the encoder 2030, the library 5110, and the signature module 5160, and the client module 1050 (i.e., a client browser 6140 within the client module 1050, as shown in FIG. 6). As shown in FIG. 6, the client browser 6140 can itself include a toggle control 6150. As shown in FIG. 5, the server 5090 can be placed in direct communication with the library 5110 and the signature module 5160 by direct connections. In one example, the server 5090 can be placed in direct communication with the library 5110 and the signature module 5160 by an internal network such as an intranet, an extranet, or other suitable internal network. In another example, the server 5090 can be configured to include the library 5110 and signature module 5160.

The server 5090 can also be configured to be generally placed in communication with the communication network 1060 such as, for example, the Internet, a local area network, a wide area network, or other suitable communication network. By configuring the server 5090 to he in communication with the communication network 1060, the server 5090 can generally communicate with other components of the system 1000 that are also in communication with the communication system 1060. The encoder 2030 and the client browser 6140 can be placed in communication with the communication network 1060 and, thus, can be placed in communication with the server 5090.

The server 5090 can include hardware and software configured to provide services to suitable clients. For example, the server 5090 can include a general purpose computer and a server operating system to provide services to other components of the information capture and playback system 1000. In one example, services can be provided by the server 5090 through direct communication to other components of the information capture and playback system 1000. In another example, services can be provided by the server 5090 through the communication network 1060 to other components of the information capture and playback system 1000. As will be subsequently discussed, the server 5090 can be configured to provide one or more services to components of the information capture and playback system 1000 such as the encoder 2030, the library 5110, the signature module 5160, the client browser 6140, or other suitable components of the system 1000.

As shown in FIG. 1, the server module 1040, and thus the server 5090, can be placed in communication with the encoder module 1010 through the communications network 1060. The server 5090 can he configured to provide suitable services to encoders 2030 through the communications network 1060. In one example, the server 5090 can provide an uploading service to encoders 2030 that allows encoders 2030 to send a request to the server 5090 to upload a data set and, upon the granting of the request by the server 5090, to upload the data set to the server 5090. Any suitable network protocol such as, for example, the file transfer protocol (FTP) can be used to upload data sets from encoders 2030 to the server 5090.

Examples of types of data that can comprise data sets uploaded from encoders 2030 to the server 5090 include video data, audio data, computer files, and digital signatures associated with the data set. The server 5090 can be configured to await a request from encoders 2030 to upload a data set from encoders 2030. The server 5090 can also be configured to monitor its system resources so that responsive actions to any request from encoders 2030 are managed efficiently. For example, if sufficient resources such as a central processing unit or random access memory are available, the server 2090 can allow encoders 2030 to upload a data set upon receiving the request for encoders 2030. However, if resources are not immediately available, the server 2090 can delay or schedule the uploading of a data set by encoders 2030 until sufficient resources become available.

One or more encoder 2030 can be configured so that if the server 5090 delays or schedules the uploading of a data set, the encoder 2030 will resend the upload request after the prescribed delay or at the scheduled time. In addition, the encoder 2030 can be configured so that if a request to the server 5090 to upload a data set is not recognized by the server 5090, the encoder 2030 will resend the request after a suitable period of time. If the uploading of a data set is prematurely terminated by, for example, an interruption in the communication network 1060, the encoder 2030 and server 5090 can be configured to either continue the uploading of the data set from the point of the interruption once the communication network 1060 interruption is cured or begin the uploading of the data set anew once the communication network 1060 interruption is cured.

The server 5090 can be configured such that once a data set is uploaded to the server 5090 from the encoder 2030, additional information or data can be incorporated into or associated with the uploaded data set. For example, information can be incorporated or associate with the uploaded data set to identify what time the data set was uploaded, the source of the uploaded data set, titles or descriptions to be associated with the uploaded data set, among other types of suitable information.

The server 5090 can also be configured to provide a downloading service to the encoder 2030. For example, the server 5090 can be configured to download or otherwise provide updated data or other such information to the encoder 2030 on a scheduled or ad hoc basis. Examples of the types of information or data that can be downloaded from the server 5090 to the encoder 2030 include updates for software that controls the encoder 2030, updates to user manuals or tutorials for the encoder 2030, a scheduled time at which the server 5090 will allow the encoder 2030 to upload a data set, and instructions for arranging data sets to be uploaded to the server 5090.

The server 5090, as shown in FIG. 5, can be placed in direct communication with the library 5110. The library 5110 can include metadata 5120. The metadata 5120 can be data about the information in the library 5110. For example, the metadata 5120 can be data about audio and visual files stored in the library 5110. It will be understood that the server 5090 can have direct access to metadata 5120 through direct communication with the library 5110. The library 5110 can be configured such that data sets can be stored and readily retrieved from the library 5110. Although a data set can be any combination of computer files, audio files, video files, and other suitable files, in one example, data sets to be stored in the library 5110 are primarily audio files and video files that are synchronized to be viewed in parallel by the end user of the information capture and playback system 1000.

To facilitate the storage and retrieval of data sets, the library 5110 can include one or more databases. The server 5090 can be configured to provide suitable services to the library 5110 through the direct communication. For example, the server 5090 can be configured to upload data sets to the library 5110 and store such data sets in the library 5110. The server 5090 can also be configured to request data sets from the library 5110 and retrieve and download data sets from the library 5110 to the server 5090.

In one example, the server 5090 can be configured so that once a data set is received from the encoder 2030 and any additional information is added to the data set by the server 5090, the data set can be uploaded to the library 5110 for storage and future retrieval. Along with the storing of the data set in the library 5110, the server 5090 can also store metadata 5120 in the library 5110 that relates to the data set stored in the library 5110. The data set can be stored such that it can be retrieved by querying the library 5110 for specific information such as, for example, title, category, date, or originating source associated with the data set. It will be understood that once the data set is identified in the library 5110 by a query, the data set can be downloaded from the library 5110 to the server 5090. In addition, metadata 5120 can be downloaded from the library 5110 to the server 5090. It will also be understood that if a query is based on a category, for example, more than one data set can be retrieved from the library 5110 and these multiple data sets can be downloaded to the server 5090.

Once data sets or metadata 5120 are stored in the library 5110, the data sets and metadata 5120 can be manually manipulated. That is, data in a data set or in metadata 5120 can be added, deleted, or changed by a system user. In addition, data sets can be manually added to the library 5110, deleted from the library 5110, or moved within the library 5110. In one example, the server 5090 can include a console. The system user can access data sets and metadata 5120 stored in the library 5110 through the server's 5090 console. The system user can, for example, change a title of a data set to better describe the subject matter of the data set or add a general category to a data set to make searching more efficient. In addition, the system user can delete data sets, add data sets, and move data sets through the console. In another example, the system user can manipulate data sets and metadata 5120 from a location that is remote from the server 5090. In such an example, the system user can access the server 5090 and, thus, the library 5110 through any suitable network protocol such as, for example, FTP.

The server 5090, as shown in FIG. 5, can be placed in direct communication with the signature module 5160. The signature module 5160 can be configured to verify a digital signature associated with a data set stored in the library 5110. As previously described, the encoder 2030 can digitally sign each data set that the encoder 2030 uploads to the server 5090 and is subsequently uploaded to the library 5110. The digital signature can be a numeric string calculated by an algorithm that is characteristic of that particular data set. The numeric string can uniquely define the data set at the time it is uploaded from the encoder 2030 to the server 5090. Upon downloading the data set from the library 5110, the server 5090 can communicate with the signature module 5160 to confirm that the data set has not been altered since it was uploaded to the library 5110 for storage. This confirmation can be achieved by the signature module 5160 applying the algorithm to the data set as downloaded from the library 5110. If the newly calculated digital signature matches the digital signal calculated and associated with the data set by the encoder 2030, it can be confirmed that the data set was not altered since it was uploaded from the encoder 2030. If the newly calculated digital signal does not the match digital signature associated with the data set, it can be confirmed that the data set has been altered since it was uploaded from the encoder 2030. When it has been determined that the data set has been altered, the server 5090 can optionally invalidate the data set. Such information can be used by the server 5090, for example, to determine whether it is appropriate for the data set to be viewed by the end user or if the data set can be passed on to the end user.

As previously discussed, the information capture and playback system 1000 can be configured to allow remote end users to request data sets for local viewing. To facilitate such viewing of data sets, the server 5090 can include a VOD module 5100. The VOD module 5100 can be configured to provide data sets to end users in a number of suitable arrangements. For example, the VOD module 5100 can continuously stream the data set to the end user, the VOD module 5100 can allow for the downloading of the data set so that the end user can store and view the data set locally, or the VOD module 5100 can live stream a data set as it is being collected and encoded by the encoder 2030.

The particular method of providing a data set to the end user for viewing can be determined by the request from the end user. The server 5090 can be configured to accept requests for data sets from other components of the information capture and playback system 1000. Provided the requested data set is stored in the library 5110, upon receipt of the request, the server 5090 can query the library 5110, locate the data set or metadata 5120, and retrieve and download data sets or metadata 5120 from the library 5110 to the server 5090. Once downloaded to the server 5090, the VOD module 5100 can provide the end user with either a streaming video feed of the data set or a download of the data set for storing and viewing locally on a component of the information capture and playback system 1000.

In one example, the client browser 6140 is a component of the information capture and playback system 1000 through which the end user can request a data set and receive a video feed or download of the data set for storing and viewing. As previously described, the client browser 6140 can be configured to be in communication with the communication network 1130 and, thus, communicate with the server 5090 through the communications network 1060. In one example, the client browser 6140 can be any number of web browsers that are commercially available for use with the World Wide Web. The server 5090 can be configured to be accessed by a client browser 6140 through the use of a specific World Wide Web address such as, for example, a uniform resource identifier (URL). The server 5090 can also be configured to provide one or more web pages that allow the end user to interact with the server 5090. The server 5090 can include a security layer that authenticates users through a security protocol. For example, a user can be required to provide a user identification and password in order to access the server 5090. The provided user identification and password can be authenticated by comparing this information to information stored in a security database located on the server 5090.

Once the end user accesses the server 5090 through the client browser 6140, the end user can provide the server 5090 with a request for one or more data sets. The server 5090 can assist the end user in requesting a data set by providing web pages with dropdown menus, search functionality, and other suitable options. Once the end user has identified a desired data set, the server 5090 can query the library 5110 and download the appropriate data set or metadata 5120 from the library 5110. The data set or metadata 5120 can then be passed onto the VOD module 5100, which can be configured to provide a download or streaming video feed of the data set to the client browser 6140 for viewing by the end user.

In one example, the end user wants to view an instructional video regarding cardiopulmonary resuscitation (CPR) techniques. The end user launches the client browser 6140 located on the end user's personal computer. The end user uses the client browser 6140 and the URL to access a main web page provided by the server 5090. The end user provides a username and password if required. Upon accessing the main web page, the end user locates a search field and enters the term CPR. The server 5090 queries the library 5110 and returns a list of titles of data sets or metadata 5120 that include the term CPR. Upon viewing the titles, the end user selects the desired title. The server 5090 again queries the library 5110 for the selected data set, locates the data set, and downloads the data set to the server 5090. Once the data set is downloaded, the server 5090 communicates with the signature module 5160 to confirm the digital signature. Provided the digital signature is confirmed, the end user is then Oven a choice between downloading the data set to the end user's personal computer for storing and streaming the data set through the VOD module 5100 to the client browser 1140 for immediate viewing. The VOD module 5100 can be configured so that the end user can start, stop, fast-forward, and rewind the video as the VOD module 5100 is streaming the video to the end user.

In another example, the end user is aware of the date, time and subject matter of a presentation that will be captured and encoded by the information capture and playback system 1000. Prior to the start of the presentation, the end user launches the client browser 6140 located on the end user's personal computer and uses the client browser and the URL to access a main web page provided by the server 5090. Through the web pages provided by the server 5090, the end user identifies the presentation and requests that the data set be streamed live to the end user through the client browser 6140. To accommodate the end user's request, the server 5090 provides the uploading service to the encoder 2030 as the encoder 2030 is encoding the presentation. A data set produced by the encoder 2030 is uploaded to the server 5090 and passed on to the VOD module 5100. The VOD module 1100 then streams the data set in real-time to the end user for viewing through the client browser 6140. Alternatively, upon the end user requesting that the presentation be streamed live to the client browser 6140, the server 5090 can direct the encoder 2030 to communicate directly to the end user's client browser 6140 through the communication network 1060.

As previously described, the data set can be comprised of multiple captured video feeds merged into one playback video. When there are two captured video feeds, for example, the playback video can display the two captured video feeds side-by-side for viewing by the end user. When there are four captured video feeds, for example, the playback video can display the four captured video feeds in two-by-two matrix for viewing by the end user. The playback video can also include multiple independent videos that are synchronized during playback. The synchronized independent videos also can be played back side-by-side or in a two-by-two matrix as described above. However, the independent videos also can be played individually. To facilitate the end user's viewing of such of independent videos of the playback video, the client browser 1140 can include the toggle control 6150. The toggle control 6150 can he configured to allow the end user to view a desired independent video. For example, a CPR instructional video can include a first independent video of a first instructor orally explaining the steps of CPR and a second independent video of a second instructor performing the steps of CPR. The toggle control 6150 allows the end user to switch between viewing both video feeds simultaneously and watching only the first instructor orally explaining the steps of CPR or watching only the second instructor performing the steps of CPR.

The above descriptions of various components and methods are intended to illustrate specific examples and describe certain ways of making and using the devices disclosed and described here. These descriptions are neither intended to be nor should be taken as an exhaustive list of the possible ways in which these components can be made and used. A number of modifications, including substitutions of components between or among examples and variations among combinations can be made. Those modifications and variations should be apparent to those of ordinary skill in this area after having read this document.

What is claimed is:

1. An apparatus comprising:
a encoder configured to:
receive an instruction datum
receive a content datum, and
receive a return processing signal that includes at least one of
a wait signal, and
an upload signal;
synchronize the content datum,
encode the content datum according to the instruction datum, and
store the encoded datum; and
a editor configured to:
control a one or more input devices,
communicate to a remote device through a communication network,
communicate a notice of available upload to the remote device upon completion of encoding,
rebroadcast the notice of available upload at a predetermined cycle upon the encoder receiving the return processing signal of the wait signal, and
upload the encoded datum upon the encoder receiving the return processing signal of the upload signal.

2. The apparatus of claim 1, wherein
encoded data comprises the content datum from each of two or more input devices; and
the encoder is further configured to encode such that:
the encoded data can be operatively selected to contemporaneously display a variety of content from the two or more input devices based on a preference, the preference comprising at least one of:
pre-defined preference, and
user selected preference.

3. The apparatus of claim 1, wherein the editor is further configured to:
communicate a notice of available livestream upload to the remote device during encoding,
rebroadcast the notice of available livestream upload at a predetermined cycle upon the encoder receiving the return processing signal of the wait signal,
upload a live stream encoded datum upon the encoder receiving the return processing signal of the upload signal, and
communicate the live stream encoded datum to a client browser through a communication network.

4. The apparatus of claim 1, wherein:
the editor is further configured to:
monitor the upload of the encoded datum, and if the upload of the encoded datum is prematurely terminated:
communicate a notice of available upload to the remote device,
rebroadcast the notice of available upload at a predetermined cycle upon the encoder receiving the return processing signal of the wait signal, and
upload the encoded datum upon the encoder receiving the return processing signal of the upload signal, wherein the upload starts at a preselected point from a group including at least one of:
an interruption point of the terminated upload, and
a beginning point of the encoded data.

5. The apparatus of claim 1, wherein the encoder is further configured to receive the instruction datum from a group comprising at least one of:
a controller,
manual entry, and
the remote device.

6. The apparatus of claim 5, wherein:
the instruction datum comprises at least one of
a pre-selected metadata, and
a communication protocol for one or more input devices; and
the encoder converts the instruction datum into a format recognized by the one or more input devices.

7. The apparatus of claim 1, wherein the content datum comprises at least one of:
an input device identifier,
a content, and
a metadata.

8. The apparatus of claim 7 wherein the content datum further comprises the content from a group including at least one of:
a one or more capture devices,
a digital signal processor,
a video editor, and
a content marker.

9. The apparatus of claim 1, wherein the encoder is further configured to encode with a digital signature.
